(19) United States
(12) Patent Application Publication
(10) Pub. No.: US 2020/0407486 A1
(43) Pub. Date: Dec. 31, 2020

(54) RESIN COMPOSITION AND CURED PRODUCT OF SAME, ADHESIVE FOR ELECTRONIC COMPONENT, SEMICONDUCTOR DEVICE, AND ELECTRONIC COMPONENT

(71) Applicant: NAMICS CORPORATION, Niigata (JP)

(72) Inventors: Nobuyuki ABE, Niigata (JP); Kazuki IWAYA, Niigata (JP)

(21) Appl. No.: 16/956,938

(22) PCT Filed: Jan. 24, 2019
(86) PCT No.: PCT/JP2019/002197

§ 371 Date: Jun. 22, 2020

(30) Foreign Application Priority Data
Jan. 26, 2018 (JP) 2018-011454

(51) Int. Cl. C08G 59/24; C08K 3/36; C08K 5/37; C09J 163/10; C09J 163/04; C08G 59/40

(52) U.S. Cl. CPC C08G 59/245; C08K 3/36; C08G 59/4021; C09J 163/10; C09J 163/04; C08K 5/37

(57) ABSTRACT

An object is to provide a resin composition which is excellent in resistance to impact when dropped after curing and which is also excellent in solvent resistance, a cured product thereof, an adhesive agent for electronic components including this resin composition, a semiconductor device and an electronic component including the cured product of this resin composition. This resin composition includes (A) a hydrogenated bisphenol A-type epoxy resin, (B) a multifunctional thiol resin, and (C) a curing catalyst. The cured product of the resin composition has an elastic modulus of 0.5 GPa or more at 50° C. The resin co sition preferably includes a glycoluril compound as the component (B).

### TECHNICAL FIELD

The present invention relates to a resin composition, a cured product of the resin composition, an adhesive agent for electronic components, a semiconductor device, and an electronic component. In particular, the present invention relates to a resin composition suitable for an adhesive agent for electronic components, and a semiconductor device and an electronic component including a cured product of this resin composition.

### BACKGROUND ART

Currently used mobile terminals and the like incorporate electronic components therein. These mobile terminals and the like are used for various applications which are required to have drop impact resistance (hereinafter, resistance to impact when dropped). Therefore, a resin composition used for, for example, the adhesion of electronic components is also required to have such resistance.

On the other hand, the resin composition used for, for example, the adhesion of electronic components is also required to have solvent resistance, in order to endure a washing process for removing solder flux, dust, or the like during a production process.

In order to improve the resistance to impact when dropped of a resin composition, there has been known a technique of lowering the glass transition temperature (lowering the Tg) of a cured product of a resin composition to decrease the elastic modulus (for example, paragraphs 0009, 0077, and 0079 to 0081 of PATENT LITERATURE 1). This technique lowers the crosslink density of a cured product of a resin composition. Therefore, the cured product of the resin composition is likely to swell. Accordingly, there is a problem that the solvent resistance deteriorates. However, a cured product having a heightened glass transition temperature (heightened Tg) has a problem that the resistance to impact when dropped deteriorates. Therefore, this cured product having a heightened Tg is not suitable for use as an adhesive agent for electronic components (for example, a voice coil motor (VCM) used for focusing cameras and an image sensor module).

### CITATION LIST

### Patent Literature

PATENT LITERATURE 1: JP-A-2012-188628

### SUMMARY OF INVENTION

### Problems to be Solved by Invention

The present invention has been made in view of the above-described problems. An object of the present invention is to provide a resin composition which is excellent in resistance to impact when dropped after curing and which is also excellent in solvent resistance, and a cured product of the resin composition. Another object of the present invention is to provide an adhesive agent for electronic components that includes this resin composition, and a semiconductor device and an electronic component that include the cured product of the resin composition.

### Solution to Problems

The present inventors conducted research for solving the above-described problems. As a result, it has been found that a resin composition including (A) an epoxy resin having a specific structure, (B) a thiol-based curing agent, and (C) a curing catalyst can have both resistance to impact when dropped and solvent resistance.

The present invention relates to a resin composition, an adhesive agent for electronic components, a semiconductor device, and an electronic component, which have solved the above-described problems by having the following configurations. [1] A resin composition including: (A) a hydrogenated bisphenol A-type epoxy resin; (B) a multifunctional thiol resin; and (C) a curing catalyst, in which a cured product of the resin composition has an elastic modulus of 0.5 GPa or more at 50° C. [2] The resin composition according to the above [1], in which the cured product further has an elastic modulus of 0.5 GPa or more at 20° C. or more and lower than 50′C. [3] The resin composition according to the above [1] or [2], in which the cured product has a glass transition temperature of higher than 50° C. [4] The resin composition according to any one of the above [1] to [3], in which the component (B) includes a multifunctional thiol resin having no ester bond in a. molecule.

[5] The resin composition according to any one of the above [1] to [4], in which the component (B) includes a glycoluril compound. [6] The resin composition according to the above [5], in which a content of the glycoluril compound of the component (B), with respect to 100 parts by mass of the component (B), is 40 to 100 parts by mass. [7] The resin composition according to any one of the above [1] to [6], further including a silica filler. [8] An adhesive agent for electronic components, including the resin composition according to any one of the above [1] to [7]. [9] A cured product of the resin composition according to any one of the above [1] to [7]. [10] A semiconductor device including the cured product according to the above [9]. [11] An electronic component including the cured product according to the above [9] or the semiconductor device according to the above [10].

### Effects of Invention

According to the present invention [1], there can be provided a resin composition which is excellent in resistance to impact when dropped after curing and which is also excellent in solvent resistance. According to the present invention [8], there can be provided an adhesive agent for electronic components which is excellent in resistance to impact when dropped after curing and which is also excellent in solvent resistance.

According to the present invention [9], there can be provided a cured product of a resin composition which is excellent in drop impact resistance and which is also excellent in solvent resistance.

According to the present invention [10], there can be provided a highly reliable semiconductor device including a cured product of a resin composition which is excellent in resistance to impact when dropped and which is also excellent in solvent resistance. According to the present invention [11], there can be provided a highly reliable electronic component including a cured product of a resin composition which is excellent in resistance to impact when dropped and which is also excellent in solvent resistance.

### BRIEF DESCRIPTION OF DRAWINGS

FIG. 1 is a DMA chart of Examples 6 and 7 and Comparative Example 3.

### DESCRIPTION OF EMBODIMENTS

The resin composition of the present invention (hereinafter, merely referred to as the resin composition) includes (A) a hydrogenated bisphenol A-type epoxy resin, (B) a multifunctional thiol resin, and (C) a curing catalyst. A cured product of the resin composition has an elastic modulus of 0.5 GPa or more at 50° C.

The hydrogenated bisphenol A-type epoxy resin of the component (A) imparts, to the resin composition, curing properties, heat resistance, adhesiveness, drop impact resistance, solvent resistance, and the like. It is noted that hydrogenated bisphenol A is also called hydrogenated bisphenol A (HBPA) or 2,2′-bis(4-hydroxycyclohexyl)propane. The component (A) sometimes contains, as impurities, a monofunctional body or a dimer. With respect to 100 parts by mass of epoxy resin in the resin composition, the content of the component (A) is preferably 65 parts by mass or more, more preferably 70 parts by mass or more, further preferably 75 parts by mass or more. When the content of the component (A) is small, the resistance to impact when dropped is likely to deteriorate. Examples of a commercially available product of the component (A) may include hydrogenated bisphenol A-type epoxy resin (product name: YX8000, YX8034, and YX8040) manufactured by Mitsubishi Chemical Corporation, hydrogenated bisphenol A-type epoxy resin (product name: Epolight 4000) manufactured by Kyoeisha Chemical Co., Ltd., and hydrogenated bisphenol A-type epoxy resin (product name: Rikaresin) manufactured by New Japan Chemical Co., Ltd. As the component (A), one of these commercially available products may be singly used, or two or more of these commercially available products may be used in combination.

The multifunctional thiol resin as the component (B) imparts, to the resin composition, elasticity and moisture resistance. The component (B) is not particularly limited, as long as it is bifunctional or higher. However, from the viewpoint of moisture resistance, a structure having no ester bond in the molecule is preferable. The component (B) more preferably includes a glycoluril compound. This component (B) has a high elastic modulus due to its rigid molecular backbone. An example of the glycoluril compound may include a compound represented by general formula (1):

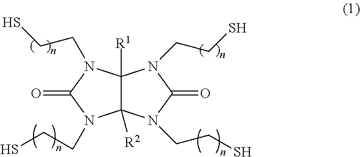

(wherein R¹ and R² are each independently hydrogen, an alkyl group of 1 to 10 carbon atoms, or a phenyl group, and n is an integer of 0 to 10). The glycoluril compound is further preferably represented by chemical formula (2) or chemical formula (3):

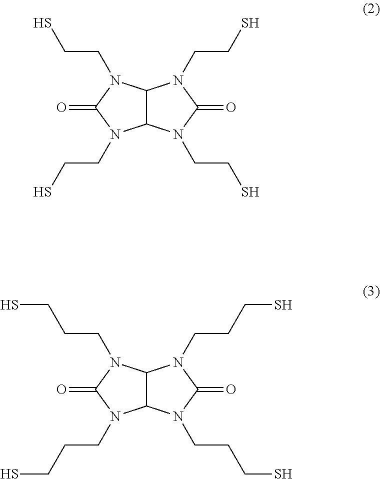 [SMILES: O=C1N(CCS)C2C(N1CCS)N(CCS)C(=O)N2CCS ; O=C1N(CCCS)C2C(N1CCCS)N(CCCS)C(=O)N2CCCS]

An example of the multifunctional thiol resin having no ester bond in the molecule may include a multifunctional thiol resin represented by general formula (4):

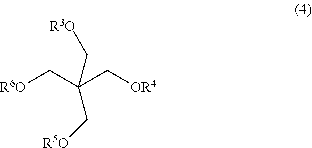

(wherein R³, R⁴, R⁵, and R⁶ are each independently hydrogen or CₙH₂ₙSH (n is 2 to 6), and at least one of R³, R⁴, R⁵, and R⁶ is CₙH₂ₙSH (n is 2 to 6)). From the viewpoint of curing properties, n of the thiol compound represented by general formula (4) is preferably 2 to 4. Also, from the viewpoint of a balance between the physical properties of a cured product and the curing speed, n of a mercaptopropyl group is more preferably 3.

Examples of a commercially available product of the component (B) may include a thiol glycoluril derivative (product name: TS-G (corresponding to chemical formula (2), thiol equivalent weight: 100 g/eq) or C3 TS-G (corresponding to chemical formula (3), thiol equivalent weight: 114 g/eq)) manufactured by Shikoku Chemicals Corporation and a thiol compound (product name: PEPT (corresponding to general formula (4), thiol equivalent weight: 124 g/eq)) manufactured by SC Organic Chemical Co., Ltd. As the component (B), one of these commercially available products may be singly used, or two or more of these commercially available products may be used in combination.

Also, from the viewpoint of the elastic modulus of the resin composition after curing, the content of the glycoluril compound as the component (B), with respect to 100 parts by mass of the component (B), is preferably 40 to 100 parts by mass, more preferably 50 to 100 parts by mass, further preferably 60 to 100 parts by mass.

The curing catalyst as the component (C) imparts, to the resin composition, curing properties. The component (C) is not particularly limited, as long as it is a common curing catalyst. An example thereof may include a curing catalyst based on phosphine or amine.

Examples of the phosphine-based curing catalyst may include triphenyl phosphine, tributyl phosphine, trip(p-methylphenyl) phosphine, and tri(nonylphenyl) phosphine. The amine-based curing catalyst includes an imidazole-based curing catalyst. Examples of the amine-based curing catalyst may include a triazine compound such as 2,4-diamino-6- [2′-methylimidazolyl-(1′)]ethyl-s-triazine, 1,8-diazabicyclo[5,4,0]undecene-7 (DBU), 1,4-diazabicyclo[2.2.2]octane (DABCO), and a tertiary amine compound including triethylene diamine, benzyldimethyl amine, triethanol amine, and the like. Examples of the imidazole curing catalyst may include an imidazole compound including 2-methyl imidazole, 2-undecyl imidazole, 2-heptadecyl imidazole, 2-ethyl-4-methyl imidazole, 2-phenyl imidazole, 2-phenyl-4-methyl imidazole, 1-cyanoethyl-2-ethyl-4-methyl imidazole, and the like. From the viewpoint of rapid curing at low temperature, 2-methyl imidazole and 1,4-diazabicyclo[2.2.2]octane (DABCO) are preferable. Examples of a commercially available product of the component (C) may include “Amicure PN-23” (Ajinomoto Fine-Techno Co., Inc., trade name), “Amicure PN-40” (Ajinomoto Fine-Techno Co., Inc., trade name), “Amicure PN-50” (Ajinomoto Fine-Techno Co., Inc., trade name), “Hardener X-3661S” (A.C.R. Co., Ltd., trade name), “Hardener X-3670S” (A.C.R. Ltd., trade name), “Novacure HX-3742” (Asahi Kasei Corp., trade name), “Novacure HX-3721” (Asahi Kasei Corp., trade name), “Novacure HXA9322HP” (Asahi Kasei Corp., trade name), “Novacure HXA3922HP” (Asahi Kasei Corp., trade name), “Novacure HXA3932HP” (Asahi Kasei Corp., trade name), “Novacure HXA5945HP” (Asahi Kasei Corp., trade name), “Novacure HXA9382HP” (Asahi Kasei Corp., trade name), “Fujicure FXR1121” (T&K TOKA Co., Ltd., trade name), “Fujicure FXE-1000” (T&K TOKA Co., Ltd., trade name), and “Fujicure FXR-1030” (T&K TOKA Co., Ltd., trade name). However, a commercially available product of the component (C) is not limited to these exemplified products. As the component (C), one of these commercially available products may be singly used, or two or more of these commercially available products may be used in combination, From the viewpoint of pot life and curing properties, the component (C) is preferably a latent curing catalyst.

From the viewpoint of balancing between the viscosity and the resistance to impact when dropped of the resin composition, the content of the component (A), with respect to 100 parts by mass of the resin composition, is preferably 10 to 70 parts by mass, more preferably 20 to 60 parts by mass, further preferably 30 to 60 parts by mass.

The thiol equivalent weight of the component (B), with respect to 1 equivalent of all epoxy, is preferably 0.5 to 2.5 equivalents, more preferably 0.5 to 2.0, further preferably 0.5 to 1.5, particularly preferably 0.8 to 1.2. When the thiol equivalent weight of the component (B) and the all epoxy equivalent weight are within the above-described range (that is, when a total of the total number of thiol groups in the resin composition and all epoxy groups is within the above-described range), the resin composition after curing can be prevented from being insufficient in hardness and toughness.

The content of the component (C). with respect to 100 parts by mass in total of the component (B) and all epoxy resin including the component (A), is preferably 0.1 to 10 parts by mass, more preferably 0.3 to 10 parts by mass, further preferably 0.5 to 10 parts by mass, When this content is 0.1 part by mass or more, reactivity is favorable. When this content is 5 parts by mass or less, heat resistance is favorable, and furthermore, a thickening factor is stable. It is noted that the component (C) may be provided in a form of a dispersion in which it is dispersed in epoxy resin. When the component (C) in such a form is used, attention is to be paid to the fact that the amount of the epoxy resin in which the component (C) is dispersed is excluded from the component (C).

In order to prevent dripping, the resin composition preferably further includes (D) an inorganic filler. The resin composition including this component (D) is suitable for dispensing. From the viewpoint of workability, the component (D) is preferably spherical. The component (D) is preferably silica or alumina.

Examples of the silica powder may include fused silica, ordinary silica stone, spherical silica, crushed silica, crystalline silica, and non-crystalline silica.

The average particle size of the component (D) is not particularly limited. However, from the viewpoint of the dispersibility of the component (D) to the resin composition and the lowering of the viscosity of the resin composition, the average particle size is preferably 0.1 to 15 μm. When the average particle size is less than 0.1 μm, the viscosity of the resin composition increases, which may deteriorate the workability of the resin composition. When the average particle size is more than 15 μm, the component (D) may be difficult to be uniformly dispersed in the resin composition. Examples of a commercially available silica powder (silica filler) may include silica (product name: SO-E2, average particle size: 0.5 μm) manufactured by Admatechs Company Limited, silica (product name: MP-8FS, average particle size: 0.7 μm) manufactured by Tatsumori Ltd., and silica (product name: FB-5D, average particle size: 5 μm) manufactured by DENKA. As the component (D), one of these commercially available products may be singly used, or two or more of these commercially available products may be used in combination.

From the viewpoint of further improvement of elastic modulus and solvent resistance, the content of the component (D) with respect to 100 parts by mass of the resin composition is preferably 0 to 40 parts by mass. When this content is more than 40 parts by mass, the resin component relatively decreases. Accordingly, the drop impact resistance may deteriorate.

The resin composition may further include, as necessary, an additive within the range that does not impair an object of the present invention. Examples of such an additive may include a stabilizer (for example, organic acid, boric acid ester, or metal chelate), carbon black, titanium black, silane coupling agent, ion trapping agent, leveling agent, antioxidant, defoamer, and thixotropic agent. Also, the resin composition may include a viscosity modifier, flame retardant, solvent, or the like.

The resin composition can be obtained by, for example, simultaneously or separately stirring, melting, mixing, and dispersing the components (A) to (C), other additives, and the like, while a heat treatment is performed as necessary. An apparatus for the mixing, stirring, dispersing, or the like is not particularly limited. A kneader, a Henschel mixer, a triple roll mill, a ball mill, a planetary mixer, a bead mill, or the like, being equipped with a stirrer and a heater, can be used. Also, these apparatuses may be used in an appropriate combination.

The resin composition obtained in this manner is heat-curable. The resin composition is preferably heat-cured at 60 to 90° C. for 30 to 120 minutes.

The cured product of the resin composition according to the present invention has an elastic modulus of 0.5 GPa or more at 50° C. Typically, drop impact resistance is improved by lowering the glass transition temperature of a cured product to room temperature or lower and reducing the elastic modulus at room temperature. Even in this case, the elastic modulus significantly increases as the temperature further decreases to lower than the glass transition temperature. Accordingly, resistance to impact when dropped deteriorates. The cured product of the resin composition according to the present invention has a glass transition temperature of higher than 50° C. Therefore, the change of the elastic modulus is small even at room temperature or further lower temperatures. Furthermore, the resistance to impact then dropped is excellent due to the component (A) used. Also, ultrasonic cleaning is often used in the washing step of electronic components, Heat generated in the ultrasonic cleaning sometimes increases the temperature of a used solvent to near 50° C. Therefore, when a cured product of a resin composition has an elastic modulus of less than 0.5 GPa at 50° C., solvent resistance deteriorates. In this manner, solvent resistance is likely to deteriorate unless the elastic modulus at 20° C. or more and lower than 50° C. is 0.5 GPa or more. In contrast to this, the cured product of the resin composition according to the present invention has a glass transition temperature of higher than 50° C. That is, the elastic modulus at 20° C. or more and lower than 50° C. is 0.5 GPa or more. Therefore, solvent resistance does not deteriorate. The cured product of the resin composition according to the present invention has an elastic modulus, at 50° C., of more preferably 0.8 GPa or more, further preferably 1 GPa or more, particularly preferably 1.5 GPa or more. Also, the upper limit of the elastic modulus of the cured product of the resin composition at 50° C. is preferably 6 GPa or less, more preferably 5 GPa or less, further preferably 4 GPa or less.

### Adhesive Agent for Electronic Components

The adhesive agent for electronic components of the present invention includes the above-described resin composition.

### Cured Product of Resin Composition

The cured product of the resin composition of the present invention is a cured product of the above-described resin composition.

### Semiconductor Device and Electronic Component

The semiconductor device of the present invention includes the above-described cured product of the resin composition. Therefore, resistance to impact when dropped is excellent. Also, high reliability can be obtained.

The electronic component of the present invention includes the above-described cured product or the above-described semiconductor device. Therefore, the electronic component of the present invention has excellent drop impact resistance and high reliability.

### EXAMPLES

Hereinafter, the present invention will be described by examples. However, the present invention is not limited to these examples. It is noted that in the following examples, parts and % indicate parts by mass and % by mass, unless otherwise stated.

As the hydrogenated bisphenol A-type epoxy resin of the component (A), hydrogenated bisphenol A-type epoxy resin (product name: YX8000, epoxy equivalent weight: 205 g/eq) manufactured by Mitsubishi Chemical Corporation was used; as the bisphenol A-type epoxy resin of the component (A), bisphenol A-type epoxy resin (product name: 828EL, epoxy equivalent weight: 173 g/eq) manufactured by Mitsubishi Chemical Corporation was used; as the siloxane backbone epoxy resin of the component (A), siloxane backbone epoxy resin (product name: TSL9906, epoxy equivalent weight: 181 g/eq) manufactured by Momentive Performance Materials Japan LLC was used;

as (B-1) C3 TS-G of the component (B), a glycoluril derivative (product name: C3 TS-G, thiol equivalent weight: 114 g/eq) manufactured by Shikoku Chemicals Corporation was used;

as (B-2) PEPT, a thiol compound (product name: PEPT, thiol equivalent weight: 124 g/eq) manufactured by SC Organic Chemical Co., Ltd. was used;
as (B-3) PEMP, pentaerythritol tetrakis(3-mercaptopropionate) (product name: PEMP, thiol equivalent weight: 128 g/eq) manufactured by SC Organic Chemical Co., Ltd. was used;
as (C-1) a curing catalyst of the component (C), a curing catalyst (product name: FXR1211) manufactured by T&K TOKA Co., Ltd. was used; as (C-2) a curing catalyst, a curing catalyst (product name: HXA3922) manufactured by Asahi Kasei Corp. was used;
as the silica of the component (D), silica (product name: SO-E2, average particle size: 0.5 μm) manufactured by Admatechs Company Limited was used; and as a silane coupling agent, 3-glycidoxypropyl trimethoxysilane (product name: KBM-403) manufactured by Shin-Etsu Chemical Co., Ltd. was used,

### Examples 1 to 8 and Comparative Examples 1 to 3

Raw materials mixed according to the formulations illustrated in Tables 1 and 2 were dispersed using a triple roll mill at room temperature. Accordingly, resin compositions of Examples 1 to 8 and Comparative Examples 1 to 3 were prepared.

### Measurement of Resistance to Impact when Dropped

### Members used for Measurement of Drop Impact Resistance Test

Member 1: SUS substrate

Part 2: Ni coat block, size: width: 9 mm×length: 9 mm×thickness: 4 mm

### Measurement Method of Drop Impact Resistance Test

(i) An SUS substrate was coated with the prepared resin composition (sample) as an adhesive agent. The coating size was width: 9 mm×length: 9 mm×thickness: 0.3 mm
(ii) On the coated sample, an Ni coat block was placed to prepare a specimen.
(iii) The specimen was put in an oven heated to 80° C. to heat cure the sample for 30 minutes.
(iv) After the sample was heat cured, the specimen was removed from the oven. At room temperature, a drop impact tester (manufactured by Hitachi Technologies and services, Ltd.) was used. The height at which the Ni coat block was peeled from the SUS plate was defined as a drop height. In the test, the drop height increased in 100 mm steps from 200 mm to 500 mm, and in 50 mm steps from 500 mm or more. Regarding the number of drops, a test was performed five times for each height. When peeling was not observed, a test proceeded to the next height. Tables 1 and 2 illustrate the results. The height of drop impact resistance is preferably 450 mm or more, more preferably 600 mm or more.

### Measurement of Elastic Modulus

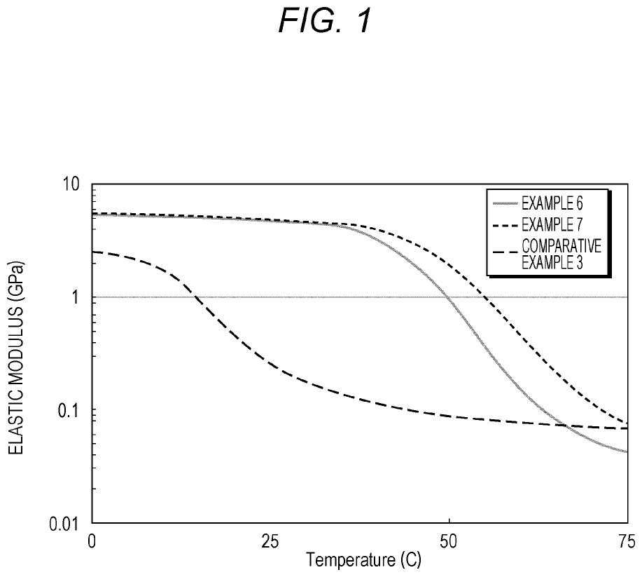

A stainless plate (made of SUS-304, smooth plate: 40 mm×60 mm×0.3 mm) was coated with the resin composition such that the cured film thickness became 500±100 μm. In this manner, a coat was formed. Thereafter, the coat was left to stand at 80° C. for 1 hour for curing. This coat was peeled from the stainless plate. Thereafter, the peeled coat was cut by a cutter into a prescribed dimension (5 mm×40 mm). The cut edge was finished with sandpaper to be smooth. This coat was measured at a frequency of 10 Hz by a tensile method in accordance with JIS C06481, using a dynamic thermomechanical analyzer (DMA) manufactured by Seiko Instruments Inc. Tables 1 and 2 illustrate storage modulus at 50° C. Although not illustrated in Tables 1 and 2, the elastic moduli of Examples 1 to 6 did not significantly change even at 0° C. Also, a temperature at which loss modulus storage modulus obtained by the DMA measurement exhibits a maximum was defined as a glass transition temperature. As the result, the glass transition temperature exceeded 50° C. in all Examples. On the other hand, Comparative Example 3 exhibited a high elastic modulus when tested at 0° C., FIG. 1 illustrates a DMA chart of Examples 6 and 7 and Comparative Example 3.

### Evaluation of Solvent Resistance

(i) The prepared resin composition (sample) was applied as an adhesive agent on an LCP substrate. The applied size was 2 mm in diameter.

(ii) On the applied sample, an alwnina chip of 3.2 mm×1.6 mm×0.45 mm in thickness was placed to obtain a specimen.
(iii) The specimen was put in an oven heated to 80° C. to heat cure the sample for 30 minutes.
(iv) The specimen was immersed in a glycol ether-based solvent at 50° C. for 30 minutes. Thereafter, the specimen removed from the solvent was rinsed with pure water. Thereafter, the rinsed specimen was dried at 80° C. for 1 hour.
(v) The shear strength at room temperature of the dried specimen was measured. The strength of 60 N or more was evaluated as acceptable.

TABLE 1

| | | Example 1 | Example 2 | Example 3 | Example 4 | Example 5 | Example 6 |
|---|---|---|---|---|---|---|---|
| Component (A) | Hydrogenated bis A-type Ep | 60 | 42 | 32 | 59 | 41 | 40 |
| Component (A’) | Bis A-type Ep | 0 | 0 | 0 | 0 | 0 | 0 |
| Component (A’’) | Siloxane backbone epoxy resin | 0 | 0 | 0 | 0 | 0 | 0 |
| Component (B) | (B-1) C3 TS-G | 33 | 23 | 24 | 33 | 23 | 12 |
| | (B-2) PEPT | 0 | 0 | 0 | 0 | 0 | 12 |
| | (B-3) PEMP | 0 | 0 | 0 | 0 | 0 | 0 |
| Component (C) | (C-1) Curing catalyst | 7 | 5 | 0 | 7 | 5 | 5 |
| | (C-2) Curing catalyst | 0 | 0 | 14 | 0 | 0 | 0 |
| Component (D) | Silica | 0 | 30 | 30 | 0 | 30 | 30 |
| Other | Silane coupling agent | 0 | 0 | 0 | 1 | 1 | 1 |
| Total | | 100 | 100 | 100 | 100 | 100 | 100 |
| Evaluation results | Drop impact resistance (unit mm) | 900 | 700 | 700 | 900 | 700 | 700 |
| | Elastic modulus (at 50° C., unit: GPa) | 2.5 | 4 | 4 | 2.5 | 4 | 0.9 |

TABLE 2

| | | | | Comparative | Comparative | Comparative |
|---|---|---|---|---|---|---|
| | | Example 7 | Example 8 | Example 1 | Example 2 | Example 3 |
| Component (A) | Hydrogenated bis A-type Ep | 41 | 41 | 0 | 40 | 0 |
| Component (A’) | Bis A-type Ep | 0 | 0 | 39 | 0 | 0 |
| Component (A’’) | Siloxane backbone epoxy resin | 0 | 0 | 0 | 0 | 39 |
| Component (B) | (B-1) C3 TS-G | 17 | 17 | 26 | 0 | 25 |
| | (B-2) PEPT | 7 | 0 | 0 | 24 | 0 |
| | (B-3) PEMP | 0 | 7 | 0 | 0 | 0 |
| Component (C) | (C-1) Curing catalyst | 5 | 5 | 5 | 5 | 5 |
| | (C-2) Curing catalyst | 0 | 0 | 0 | 0 | 0 |
| Component (D) | Silica | 30 | 30 | 30 | 30 | 30 |
| Other | Silane coupling agent | 1 | 1 | 1 | 1 | 1 |
| Total | | 100 | 100 | 100 | 100 | 100 |
| Evaluaton results | Drop impact resistance (unit mm) | 700 | 700 | 200 | 500 | 800 |
| | Elastic modulus (at 50° C., unit: GPa) | 2 | 1.5 | 3.5 | 0.13 | 0.09 |

TABLE 3

| | Example | Example | Example | Comparative | Comparative |
|---|---|---|---|---|---|
| | 2 | 6 | 7 | Example 2 | Example 3 |
| Solvent | Accept- | Accept- | Accept- | Un- | Un- |
| resistance | able | able | able | acceptable | acceptable |

As understood from Tables 1 and 2, all of Examples 1 to 8, in which the resin composition including the components (A) to (C) was used, had an elastic modulus of 0.5 GPa or snore and a favorable drop impact resistance value. Of Examples having an elastic modulus of 0.5 GPa or more, Examples 2, 6 and 7, which were subjected to a solvent resistance test, all exhibited a shear strength of 100 N or more in the evaluation of solvent resistance. As illustrated. in Table 3, it was confirmed that the evaluation results of the solvent resistance for these Examples are favorable. On the contrary, the drop impact resistance of Comparative Example 1, in which the component (A) was not included, deteriorated. Comparative Example 2, which had a low elastic modulus at 50° C., included the component (A), but exhibited poor solvent resistance due to a low elastic modulus. Comparative Example 3, in which the component (A) was not included, exhibited poor solvent resistance due to a low elastic modulus.

The resin composition of the present invention is excellent in drop impact resistance after curing and is also excellent in solvent resistance. Therefore, this resin composition is extraordinarily useful. Also, a semiconductor device and electronic component including a cured product of this resin composition have high reliability due to excellent resistance to impact when dropped.

1. A resin composition comprising:
(A) a hydrogenated bisphenol A-type epoxy resin;
(B) a multifunctional thiol resin; and
(C) a curing catalyst, wherein
a cured product of the resin composition has an elastic modulus of 0.5 GPa or more at 50° C.

2. The resin composition according to claim 1, wherein the cured product further has an elastic modulus of 0.5 GPa or more at 20° C. or more and lower than 50° C.

3. The resin composition according to claim 1, wherein the cured product has a glass transition temperature of higher than 50° C.

4. The resin composition according to claim 1, wherein the component (B) includes a multifunctional thiol resin having no ester bond in a molecule.

5. The resin composition according to claim 1, wherein the component (B) includes a glycoluril compound.

6. The resin composition according to claim 5, wherein a content of the glycoluril compound of the component (B), with respect to 100 parts by mass of the component (B), is 40 to 100 parts by mass.

7. The resin composition according to claim 1, further comprising a silica filler.

8. An adhesive agent for electronic components, comprising the resin composition according to claim 1.

9. A cured product of the resin composition according to claim 1.

10. A semiconductor device comprising the cured product according to claim 9.

11. An electronic component comprising the cured product according to claim 9.

12. An electronic component comprising the semiconductor device according to claim 10.
